(19) United States
(12) Patent Application Publication
(10) Pub. No.: US 2012/0254261 A1
(43) Pub. Date: Oct. 4, 2012

(54) DIGITAL TRAVEL RECORD

(75) Inventors: Stacey A. Edwards, Cherry Hill, NJ (US); Cheryl James, Berwyn, PA (US); Michel LaBianca, Scottsdale, AZ (US); Dilip Karandikar, Phoenix, AZ (US); Harg Malhi, Phoenix, AZ (US); Mark B. McCulloch, Phoenix, AZ (US); Kelly Marle Moody, Phoenix, AZ (US)

(73) Assignee: American Express Travel Related Services Company, Inc., New York, NY (US)

(21) Appl. No.: 13/076,985

(22) Filed: Mar. 31, 2011

(51) Int. Cl. G06F 17/30

(52) U.S. Cl. 707/810; 707/E17.048

(57) ABSTRACT

Methods, systems and computer readable medium are provided for assisting with creating a digital traveler record. The system may be configured for collecting transaction account data particular to a transaction account, global distribution system data particular to a transaction account holder, and/or passenger name record data particular to a transaction account holder. The method may include modifying the collected data for integration with a service oriented architecture framework. This method may further include delivering the modified data as a module for use by an application.

### FIELD

The present disclosure generally relates to an electronic digital traveler record. More particularly, the disclosure relates to accounting for items associated with booking travel, traveling and capturing travel related information in a convenient location. Global booking data is aggregated into a service oriented architecture/XML repository using proprietary parsing, normalization and data enrichment to then feed other applications and create web services to be used in a broad range of applications in the travel industry.

### SUMMARY

The present disclosure provides methods, systems and non-transitory computer-readable medium for capturing information associated with travel. A system for creating a digital travel record is disclosed. A method may include collecting transaction account data particular to a transaction account, global distribution system data particular to a transaction account holder, and/or passenger name record data particular to a transaction account holder. The method may also include modifying the collected data for integration with a service oriented architecture framework and delivering the modified data as a module for use by an application. The method may include aggregating the collected data of a plurality of transaction account holders to provide an enterprise level digital travel record. In one exemplary embodiment, the enterprise level digital travel record may be configured for sorting based on key field indicators.

The transaction account data particular to a transaction account, global distribution system data particular to a transaction account holder, and/or passenger name record data particular to a transaction account may be collected without queue polling a third party source and/or collected without passive data capture, such as by using the technique of messaging queuing. The transaction account data may include parking fees, transportation fees, baggage fees, mobile network access fees, meals, entertainment, preferred vendor status, fees associated with shipping goods, alerts associate with a travel booking, business services fees, fax fees, printing fees, mobile plan change fees, premium seating upgrade fees, preferred booking fees, change of flight fees, and/or loyalty club access fees. The system may be a scalable web services product configured for integration with a third party provider application. Delivered data associated with the above disclosed system may be available in real time or near real time.

The system may be configured to collect free text data entry and/or configured to support bi-directional communication, such as to support localization of users based on, for example, digital travel record data. The method may include comprising transmitting a targeted localization request based on the digital travel record data to a mobile communication device of the transaction account holder. The user mobile device may be configured to provide localization data in response to the received transmission. In one exemplary embodiment, user support services may be balanced in response to the returned response data. Crisis management may be provided by the system based on the returned response data.

A trip bucket summary based on the digital travel record data may be provided, wherein the trip bucket summary includes at least one of cost associated with travel prior to, during, and/or after travel. The method may include storing the digital travel record data to a repository.

Further features and advantages of the present disclosure as well as the structure and operation of various embodiments are described in detail below with reference to the accompanying drawings.

### BRIEF DESCRIPTION OF THE DRAWINGS

A more complete understanding of the disclosure may be derived by referring to the detailed description and claims when considered in connection with the Figures, wherein like reference numbers refer to similar elements throughout the Figures, and:

FIG. 1 is an overview of an exemplary trip bucket, in accordance with various embodiments;

FIG. 2 is an exemplary block diagram of the base structure of the digital traveler record, in accordance with various embodiments;

FIG. 3A is an exemplary screen shot of data presented using the DTR system in accordance with various embodiments; and

FIG. 3B is an exemplary screen shot of expanded data from FIG. 3A presented using the DTR system in accordance with various embodiments.

### DETAILED DESCRIPTION OF EXEMPLARY EMBODIMENTS

The detailed description of exemplary embodiments described herein makes reference to the accompanying drawings, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

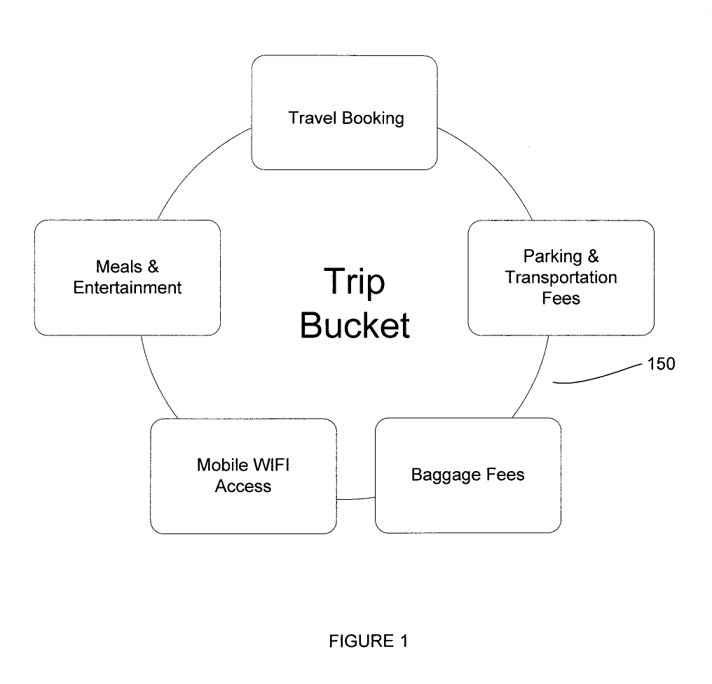

The present disclosure is directed to systems, methods and computer readable medium for providing a digital traveler record. In one exemplary embodiment, a digital traveler record may account for items associated with travel, such as a business trip. The collection of data may start prior to, contemporaneously with and/or post travel. For instance, the DTR data collection may start in response to a traveler making a first travel expense until they return and complete their expense report and/or are reimbursed for their travel expenses. The DTR system my combine multiple data sources (such as a transaction account, third party vendor, global distribution system (GDS)/passenger name record (PNR), traveler profiles, etc.) into a comprehensive “trip bucket” 150 for each traveler & trip (See FIG. 1). DTR system 100 may publish this trip bucket 150 information. For instance, the trip bucket 150 information and/or DTR data may be published to third party providers. This trip bucket 150 information and/or DTR data may be cross-referenced and/or combined with additional data to provide new services real time to individual travelers and/or corporate clients. Parking fees, transportation fees, baggage fees, mobile network access fees, meals, entertainment, preferred vendor status, fees associated with shipping goods, alerts associate with a travel booking, business services fees, fax fees, printing fees, mobile plan change fees, premium seating upgrade fees, preferred booking fees, change of flight fees, and/or loyalty club access fees, and the like may be included in the trip bucket 150.

DTR system 100 may be configured for use in a service oriented architecture (SOA) enabled data repository for travel bookings, including global distribution system and non-global distribution system travel bookings. Global distribution system and passenger name record data may be initially synched to the digital travel record via queue polling. In one exemplary embodiment, using queue polling, the system may check each global distribution system queue and determines if data is pending and in response to data being pending transfer the data. In some embodiments, direct updates from the global distribution system may be used (as direct updates become available). Messaging queuing may be implemented by DTR system 100. For instance, DTR system 100 may be configured to automatically pull data from the global distribution system based on specific triggers. This may allow for faster processing and higher volumes. Also, web services may be implemented as needed to streamline data collection and communication. For instance, web services may comprise an application programming interface that allows constant messaging or communication between two systems in a service oriented architecture environment. This may eliminate use of batch processing. In other words, various implementations of DTR system 100 may operate without (with minimal or regardless of) batch processing and/or queue polling. A service interface layer may be implemented in DTR system 100 which enables integration of travel related data from various sources (transaction account, expenses, etc). In one exemplary embodiment, these data sources are available to downstream business intelligence systems in substantially near-real-time. In one exemplary embodiment, global booking data may be aggregated into a service oriented architecture/XML repository using proprietary parsing, normalization and data enrichment to then feed other applications and create web services to be used in a broad range of applications in the travel industry.

DTR system 100 may be configured for use in a service oriented architecture (SOA) enabled data repository for travel bookings, including global distribution system and non-global distribution system travel bookings. The service oriented architecture may be a flexible set of design principles used during the phases of systems development and integration in computing. The service oriented architecture may provide a way for consumers of services, such as web-based applications, to be aware of the available SOA-based services. Global distribution system and passenger name record data may be initially synched to the digital travel record via queue polling. In one exemplary embodiment, using queue polling, the system may check each global distribution system queue and determines if data is pending and in response to data being pending transfer the data. In some embodiments, direct updates from the global distribution system may be used (as direct updates become available). In various embodiments, messaging queuing may be implemented by DTR system 100. For instance, DTR system 100 may be configured to automatically pull data from the global distribution system based on specific triggers. This may allow for faster processing and higher volumes. Also, web services may be implemented as needed to streamline data collection and communication. For instance, web services may comprise an application programming interface that allows constant messaging or communication between two systems in a service oriented architecture environment. This may eliminate use of batch processing. In other words, various implementations of DTR system 100 may operate without batch processing and/or queue polling. A service interface layer may be implemented in DTR system 100 which enables integration of travel related data from various sources (transaction account, expenses, etc). In one exemplary embodiment, these data sources are available to downstream business intelligence systems in substantially near-real-time.

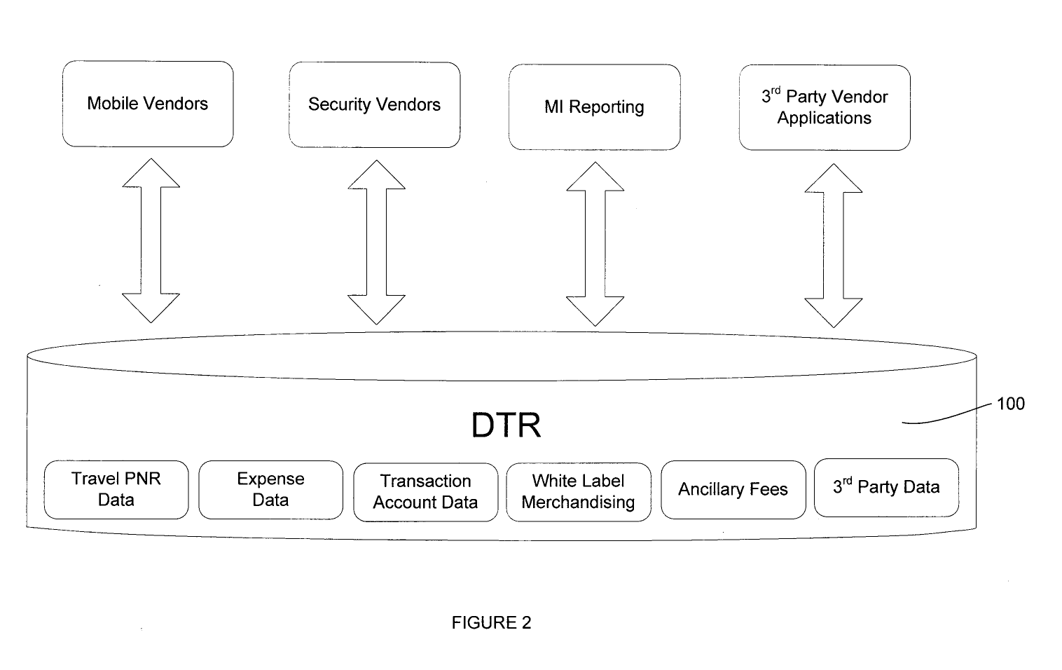

For instance, and with reference to FIG. 2, in one exemplary embodiment, DTR system 100 may comprise inbound data capture, such as incorporating transportation data from a transportation data provider. DTR system 100 may further comprise inbound web services, such as capturing incoming transportation transaction data. DTR system 100 may further comprise messaging queuing to capture transaction account data directly from the global distribution system. Moreover, DTR system 100 may comprise outbound web services for proving data to third party providers, such as preferred vendors or clients. These preferred vendors and/or clients may have pre-existing contracts for discounts and benefits.

DTR system 100 may be flexible and scalable to support the processing of any suitable integer of user travel data. For instance, the DTR system may be scalable to process about 500,000 concurrent user data pulls or data pushes to and from the DTR system 100. In one embodiment, this flexibility is provided through the use of a XML repository. DTR system 100 may be a flexible application due to its normalized structure and use of XML technology. This flexibility may allow for the creation of a Trip Bucket 150, combining all of the expenses and characteristics of a traveler's trip into a configurable record. With the use of standard XML formats and OpenTravel Alliance (OTA) compliant schemas, DTR system 100 may be adapted to provide the data elements needed, providing additional layers of security and privacy for traveler data. DTR system 100 is also designed to be scalable, allowing DTR system 100 to expand throughput options as loads increase. DTR system 100 may be the foundation for capturing travel related items, such as travel reservations, expenses, and profiles, into one source that may be shared efficiently via a web services delivery.

In one exemplary embodiment, DTR system 100 may be configured to provide community communication services. For instance, DTR system 100 allows for a social networking implementation via any known or developed social networking system (e.g., Facebook, Twitter, etc). This may allow travelers to share information as desired, such as for communication with other business travelers. DTR system 100 may be configured for sharing feedback on hotels, restaurants, and places to entertain clients in various cities. For instance, this feedback may be entered into DTR system 100 via free text entry (and associated free text data storage). DTR system 100 can link travelers from the same and different companies together to facilitate trip planning. Travelers will also have the opportunity to see if other counterparts are traveling to the same location to coordinate transportation and set up networking events. The community services offer a wide variety of information to the individual traveler and allow travelers to communicate with one another.

DTR system 100 may be configured to provide crisis management localization. For instance, DTR system 100 may capture traveler bookings directly from the global distribution systems via event notification or from Non-global distribution systems sources as changes are made. In response to changes to a traveler's itinerary or an ‘event’ an update of the Trip Bucket 150 in DTR may be triggered. Thus, in one embodiment, up-to-date traveler location information is captured. In response to a crisis event occurring, DTR system 100 may contain the most accurate location of the traveler, allowing for quick identification of impacted users (i.e. travelers). With the inclusion of specific transaction account data, such as a corporate transaction account combined with traveler profile data, DTR system 100 may comprise a single location to identify impacted travelers via either travel itinerary or transaction account transactions and link to impacted travelers information for personal, business and mobile services and emergency contacts for rapid assessment of a travelers whereabouts and safety.

The DTR system may use this crisis management information to reallocate call center/support services. For instance, the DTR system may locate a stored mobile device contact code of a user. The DTR may contact the user via the retrieved contact code in a noninvasive way such as via passive bi-directional communication or requesting the user to respond to a simple query. In response, the user may return their current geographic coordinates and the DTR system may determine if the user is impacted by the crisis. DTR system 100 may also balance user services support in response to the returned response data.

DTR system 100 may have a custom OpenTravel Alliance (OTA) system 200 and interface. One example of an OpenTravel Alliance (OTA) is a self-funded, non-profit organization comprised of major airlines, hoteliers, car rental companies, leisure suppliers, travel agencies, global distribution systems, technology providers, and other interested parties working to create and implement industry-wide, open e-business specifications. A common e-business language may be implements in DTR system 100 to create new collections of services to better meet the demands and expectations of travelers and the travel industry. Based on the OTA standards widely accepted, DTR system 100 may comprise a flexible custom output for clients & vendors based on their individual needs. In contrast to providing an overall data dump of all fields, a customized OTA 200 may be implemented to share a portion of the available information, resulting in stronger data privacy characteristics and allowing access to information on a strictly “need to know” basis. This customized OTA may yield system efficiency, ensuring that throughput and web services delivery mechanisms do not waste system resources by, for example, sending unnecessary data. This customized OTA may benefit both to the sender and recipient, as the recipient no longer needs to cull through hundreds of fields in a flat file to extract data for their purpose.

In some embodiments, DTR system 100 comprises a trip bucket 150. The digital traveler record may be configured to account for items such as expenditures associated with a trip. DTR system 100 may take every component from a trip, such as corporate transaction account data, travel information, and fees or expenses, and link them together to create trip bucket 150. This trip bucket 150 may be a digital container for everything associated with the trip. In one exemplary embodiment, the trip bucket 150 may be a centralized review for expenses, purchases, and travel details, allowing the complete cost of the trip to be calculated. Also, based on comparing trip buckets 150 of more than one user, market services may be evaluated and updated based upon traveler behavior. Additionally, customized marketing may be provided to users based on historical trip bucket 150 analysis. In some embodiments, third party travel vendors associated with data based services may be granted access to certain DTR systems 100. Examples might include mobile/SMS providers, traveler security firms, business intelligence, expense management system providers, online booking engines, travel insurance providers and the like.

In some embodiments, operating costs may decrease due to decreased reliance upon global distribution system scan hits to capture traveler passenger name record data. DTR system 100 may provide improved timeliness and accuracy of data. DTR system 100 may also provide the baseline infrastructure needed to support new web and mobile based applications.

In one exemplary embodiment, DTR system 100 provides seamless (or almost seamless) content sourcing from global distribution system and non-global distribution system channels. DTR system 100 may also be configured to reduce scan hit rates via the elimination of queue polling. DTR system 100 may eliminate passive segments for travel data capture. The transaction account, such as a corporate transaction account, may be integrated with other travel data. DTR system 100 may provide substantially near-real-time data availability. DTR system 100 may provide improved data quality. Additionally, the functionality of DTR system 100 may provide simplification and consolidation of existing systems.

DTR system 100 may be configured to capture if the traveler is booking with a preferred vendor stored in a preferred vendor database. DTR system 100 may capture if the traveler or persons associated with the traveler will be shipping anything to the destination prior in connection with their travels. DTR system 100 may centralize alerts the traveler may be receiving associated with their travel. DTR system 100 may capture any business services fees including copying, faxing, and printing associated with the trip. DTR system 100 may be configured to present notifications of additional travel fees, such as airline fees for baggage, meals, premium seating, etc. DTR system 100 may be capable of capturing components of a trip, such as transaction account data, travel information, any fees or expenses and link them together for an overall trip cost. DTR system 100 may be modified to capture a narrative of the purpose of the travel and/or who provided authorization for the expenses. DTR system 100 may present a total allocation and decrement the total allocation per trip as expenses are incurred.

DTR system 100 is configured to provide pre-trip, on-trip and post-trip information as it relates to a traveler. The information captured includes not only the traditional aspects of travel (e.g. air, car, hotel, rail, and transportation services such as limo, executive car, and taxi) but also includes the integration of other data sources such as transaction account data and other third party services. The platform may provide the ability to parse data into components unlocking the ability to target content, services, and marketing to travelers prior to, during or after a trip. DTR system 100 may allow the migration from direct global distribution system queues to an automated substantially real-time secure feed. The service oriented architecture may allow access to data via web services. A reduction in scan hits is achieved by implementing event based notification and passenger name record data provisioning provided by third party vendors. A reduction in passive segments is achieved by incorporating data from non-global distribution system sources. Improved management infrastructure and data quality may increase user satisfaction. Also, data content may be improved for global distribution system booking. DTR system 100 may be configured to support all known and future developed global distribution system content providers.

Data may be stored as long as is desired. For instance, in some embodiments data is stored for approximately 50 months. DTR system 100 may poll or accept push from major global distribution system providers. DTR system 100 may be configured for 1 traveler per passenger name record or more than one traveler per passenger name record. In some embodiments, passenger name records are configured in DTR system 100 to be parsed in XML format. The XML can be expanded if needed.

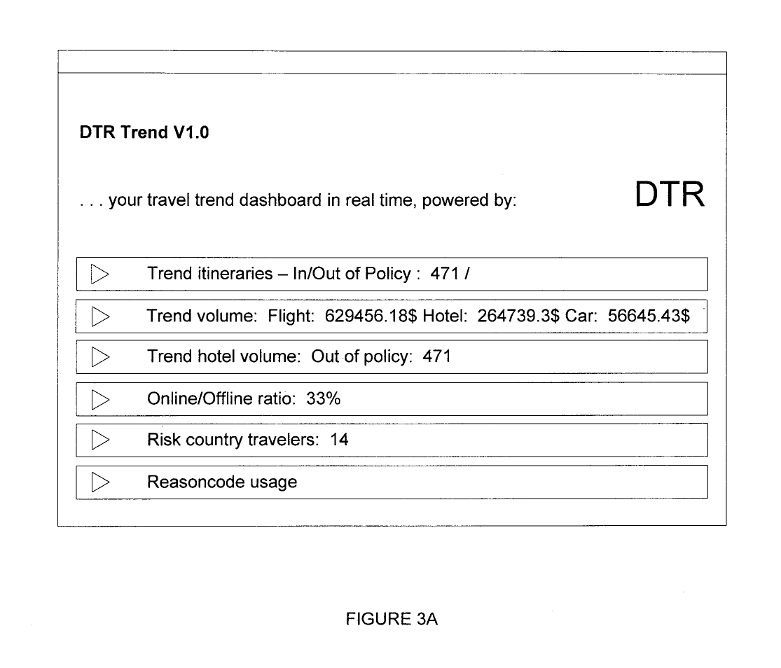

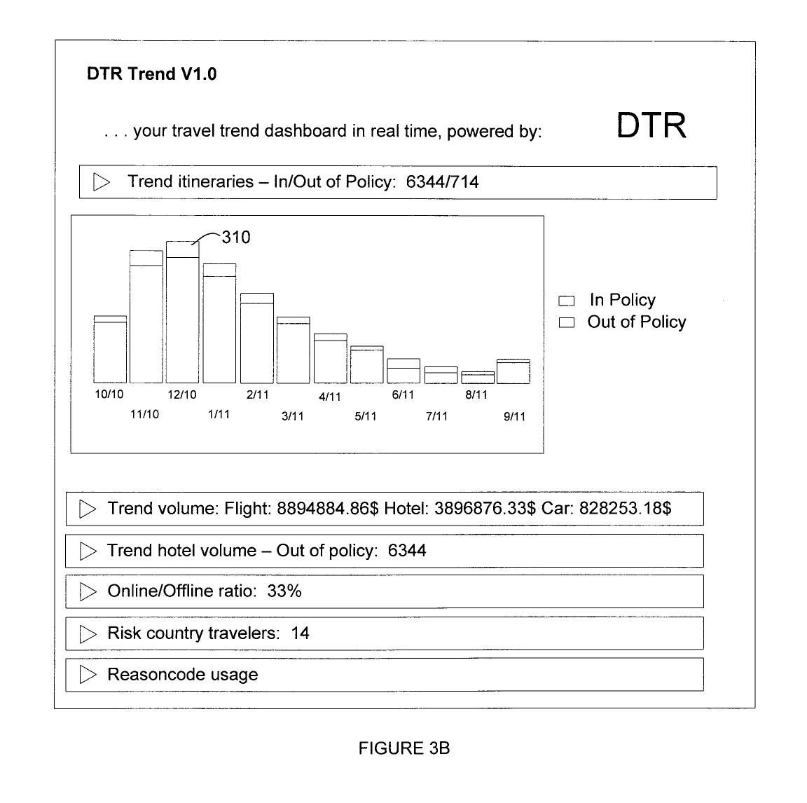

The trip bucket 150 data and/or DTR system 100 data may be configured to be presented in an application. For instance, this application may be a third party vendor application. In an exemplary embodiment, this application may be configured for a corporate travel service provider to track travel costs of the organization. For instance, an interface coupled to the application may provide data, such as aggregate user travel data. With reference to FIG. 3A, an aggregate of the collected data of users may be assembled to provide an enterprise level digital travel record. In some embodiments, a designated number, such as the top six key performance indicators 310 may used to sort and present the DTR system data. These key performance indicators 310 may be selected by client management, the user, or a third party. Examples of key performance indicators 310 include, trend itineraries, trend volume, trend hotel volume, online/offline ratio, risk country travelers, and reason code usage. With reference to FIG. 3B, by clicking on the key performance indicator 310, expanded information may be presented. For instance, the number of bookings per day, 14 day and 21 day ahead, and/or the number of bookings out of policy may be presented.

The traveler may be a transaction account holder (i.e. card members). “Account holders”, or similar phrases as used herein, may include any individual, group, charity, entity, software and/or hardware that is associated with an account in certain ways, such as a user, customer, member, rights holder, benefit from the account, affiliated with the account and/or the like. Transaction account holders may include all (or any subset of) account holders associated with a particular issuer, account holders with a certain type of account, primary account holders, subsidiary account holders, relatives of account holders, responsible parties of account holders, parties impacted by the account and/or the like.

Transaction accounts may include transaction instruments such as credit cards, debit cards, pre-paid cards, charge cards, gift cards, corporate cards, affinity cards, and the like. The transaction instruments may be issued by a transaction account issuer, for example, American Express.

The present disclosure is now described in terms of an exemplary system, hereinafter referred to as a DTR system 100. In one embodiment, DTR system 100 may be deployed by any entity, such as a transaction account issuer, financial institution, merchant, and/or third party service and/or vendor. The nomenclature used herein is for convenience only and is not intended to limit the application of the present disclosure. It will be apparent to one skilled in the relevant art how to implement the present disclosure in alternative embodiments.

The different elements shown in DTR system 100 may communicate with each other over a network. As used herein, the term “network” may include any cloud, cloud computing system or other communication means which incorporates both hardware and software components of such. Communication among the parties in accordance with the present disclosure may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, cloud computing, transponder communications, local area network (LAN), wide area network (WAN), networked or linked devices, keyboard, mouse and/or any suitable communication or data input modality over any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); and Loshin, TCP/IP Clearly Explained (1997) and David Gourley and Brian Totty, HTTP, The Definitive Guide (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

DTR system 100 (or any of the other components described herein) may further include a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor and/or database. With renewed reference to FIG. 2, various databases used herein, may include databases for storing: Travel PNR data, GDS data, Expense data, transaction account data, white label merchandising, ancillary fees, third party data, and/or like databases useful in the operation of DTR system 100. These databases may be configured for communication with mobile vendors, security vendors, management infrastructure reporting, and/or third party vendor applications. As will be appreciated by one of ordinary skill in the art, one or more of the components of the system may be embodied as a customization of an existing system, an add-on product, upgraded software, a stand alone system, a distributed system, a method, a data processing system, a device for data processing, non-transitory tangible computer readable medium, non-transitory memory communicating with a processor and/or a computer program product. Accordingly, individual system components may take the form of an entirely software embodiment, an entirely hardware embodiment, or an embodiment combining aspects of both software and hardware. Furthermore, individual system components may take the form of a computer program product on a non-transitory computer-readable storage medium having computer-readable program code means embodied in the storage medium. Any suitable computer-readable storage medium may be utilized, including hard disks, CD-ROM, optical storage devices, magnetic storage devices, and/or the like.

One skilled in the art will appreciate that DTR system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

One skilled in the art will also appreciate that, for security reasons, any database, system, device, server or other component of DTR system 100 may consist of any combination thereof at a single location or at multiple locations, wherein each database or system includes any of various suitable security features, such as firewalls, access codes, encryption, decryption, compression, decompression, and/or the like.

While the steps outlined above represent a specific embodiment, practitioners will appreciate that there are any number of computing algorithms and user interfaces that may be applied to create similar results. The steps are presented for the sake of explanation only and are not intended to limit the scope of the disclosure in any way.

The disclosure has been described herein in terms of functional block components, screen shots, optional selections and various processing steps. It should be appreciated that such functional blocks may be realized by any number of hardware and/or software components configured to perform the specified functions. For example, DTR system 100 may employ various integrated circuit components, e.g., memory elements, processing elements, logic elements, look-up tables, and/or the like, which may carry out a variety of functions under the control of a microprocessor or other control device. Similarly, the software elements of DTR system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that DTR system 100 may employ any number of conventional techniques for data transmission, signaling, data processing, network control, and/or the like. Still further, DTR system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneider, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a non transitory computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, cloud computing, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the disclosure. It should be understood that the detailed description and specific examples, indicating exemplary embodiments, are given for purposes of illustration only and not as limitations. Many changes and modifications within the scope of the instant disclosure may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an exemplary embodiment, B alone may be present in an exemplary embodiment, C alone may be present in an exemplary embodiment, or that any combination of the elements A, B and C may be present in a single embodiment; for example, A and B, A and C, B and C, or A and B and C.

We claim:

1. A method comprising:
collecting, by a computer based system for creating a digital travel record, at least one of transaction account data particular to a transaction account, global distribution system data particular to a transaction account holder, and passenger name record data particular to a transaction account holder;
modifying, by the computer based system, the collected data for integration with a service oriented architecture framework; and
delivering, by the computer based system, the modified data as a module for use by an application.

2. The method of claim 1, further comprising aggregating, by the computer based system, the collected data of a plurality of transaction account holders to provide an enterprise level digital travel record.

3. The method of claim 2, wherein the enterprise level digital travel record is configured for sorting based on key field indicators.

4. The method of claim 1, wherein at least one of the transaction account data particular to a transaction account, global distribution system data particular to a transaction account holder, passenger name record data particular to a transaction account is collected without queue polling a third party source.

5. The method of claim 1, wherein at least one of the transaction account data particular to a transaction account, global distribution system data particular to a transaction account holder, and passenger name record data particular to a transaction account is collected using messaging queuing.

6. The method of claim 1, wherein the transaction account data comprises at least one of parking fees, transportation fees, baggage fees, mobile network access fees, meals, entertainment, preferred vendor status, fees associated with shipping goods, alerts associate with a travel booking, business services fees, fax fees, printing fees, mobile plan change fees, premium seating upgrade fees, preferred booking fees, change of flight fees, and loyalty club access fees.

7. The method of claim 1, wherein at least one of the transaction account data particular to a transaction account, global distribution system data particular to a transaction account holder, and passenger name record data particular to a transaction account is collected without passive date capture.

8. The method of claim 1, further comprising providing a scalable web services product configured for integration with a third party provider application.

9. The method of claim 1, wherein the delivered data is available near real time.

10. The method of claim 1, further comprising collecting free text data entry.

11. The method of claim 1, wherein the application is configured to support bi-directional communication.

12. The method of claim 1, wherein the application is configured to support bi-directional communication for localization of users.

13. The method of claim 12, wherein the application is configured to support bi-directional communication for localization of users based on the digital travel record data.

14. The method of claim 13, further comprising transmitting, by the computer based system, a targeted localization request based on the digital travel record data to a mobile communication device of the transaction account holder, wherein the user mobile device provides localization data in response to the received transmission.

15. The method of claim 14, further comprising balancing user services support in response to the returned response data.

16. The method of claim 14, further comprising providing crisis management based on the returned response data.

17. The method of claim 1, wherein the application is configured to provide a trip bucket summary based on the digital travel record data, wherein the trip bucket summary includes at least one of cost associated with travel prior to, during, and after travel.

18. The method of claim 1, further comprising storing the digital travel record data to a data repository.

19. A system comprising:
a tangible, non-transitory memory communicating with a processor for creating a digital travel record, the tangible, non-transitory memory having instructions stored thereon that, in response to execution by the processor, cause the processor to perform operations comprising:
collecting, by the processor, at least one of transaction account data particular to a transaction account, global distribution system data particular to a transaction account holder, and passenger name record data particular to a transaction account holder;
modifying, by the processor, the collected data for integration with a service oriented architecture framework; and
delivering, by the processor, the modified data as a module for use by an application.

20. An article of manufacture including a non-transitory, tangible computer readable medium having instructions stored thereon that, in response to execution by a computer-based system for creating a digital travel record, cause the computer-based system to perform operations comprising:
collecting, by the computer based system, at least one of transaction account data particular to a transaction account, global distribution system data particular to a transaction account holder, and passenger name record data particular to a transaction account holder;
modifying, by the computer based system, the collected data for integration with a service oriented architecture framework; and
delivering, by the computer based system, the modified data as a module for use by an application.
